(19) United States
(12) Patent Application Publication
(10) Pub. No.: US 2017/0080749 A1
(43) Pub. Date: Mar. 23, 2017

(54) Optimized Rim For Robust Pneumatic Bicycle Wheel Functionality

(71) Applicant: Raymond Anderson Scruggs, San Anselmo, CA (US)

(72) Inventor: Raymond Anderson Scruggs, San Anselmo, CA (US)

(21) Appl. No.: 14/862,643

(22) Filed: Sep. 23, 2015

(51) Int. Cl. B60B 21/10; B60C 19/12; B60B 21/04; B60C 15/02

(52) U.S. Cl. CPC B60B 21/10; B60C 15/0206; B60C 19/12; B60B 21/04; B60B 21/12

(57) ABSTRACT

A bicycle wheel rim design with high safety margin and optimized strength-to-weight is described. The rim provides a tire bead supporting platform which defines a circumferential bead seat with minimum bead seat diameter equal to the standard tire bead diameter defined for a particular size of tire. Each tire bead seat defined along the rim circumference is comprised by a pair of circumferential ridges. The circumferential ridges comprise the external sidewalls of the rim and do not include tire bead hook features, and are of optimized sidewall thickness to add load strength and lateral stiffness, and resist crushing from impact. The interior ridges are increased diameter towards the medial plane of the rim to a value greater than the specified tire bead diameter. Given this geometry, the left lateral and right lateral of each tire bead is safely constrained within the defined bead seats under a wide variety of uses.

### BACKGROUND

Bicycle wheel rims retain a bicycle tire in place, and provide attachment points for spokes form an axle hub. Rim in come cases provide braking surfaces. The wheel rims are subject to a variety of forces, including forces that are generated during acceleration, turning, braking, and impacts as the tire passes over variations in the terrain, and forces exerted on the rim by the inflated tire and other forces. For high performance applications, such as jumps, descending, climbing, sprinting or bicycle racing, the mass, and rotational inertia the bicycle rim are also significant design considerations.

The the problem with prior bicycle designs having effective tire retention but are insufficiently robust for good durability, or a robust design that includes a rim wall bead hooks, an unnecessary design feature, that increase material weight with no tire retention benefit.

There is a prior design that does secure a tire in the rim when a flat occurs, but the design is not of optimum robust design to prevent rim damage once a tire becomes deflated. See Patent application: US20090115240 , and granted U.S. Pat. No. 6,257,676.

The optimized robust rim wall is designed without tire bead hooks, which weaken the rim wall unnecessarily. A bicycle rim wall without tire bead hooks has been described in a patent application previously, but without sufficient wall thickness to optimize robust rim durability. See Patent application: US20110084543

### BRIEF SUMMARY OF THE INVENTION

The rim design provides a tire bead supporting platform which defines a circumferential bead seat with minimum bead seat diameter equal to the standard tire bead diameter defined for a particular size of tire. For example, the bead seat diameter may be XXX mm for use with a size XXXX tire, or YYY mm for use with a size YYYY tire. Each tire bead seat defined along the rim circumference is comprised by a pair of circumferential ridges. The exterior circumferential ridges comprise the external sidewalls of the rim and do not include tire bead hook features, and are of optimized sidewall thickness to add load strength and lateral stiffness, and resist crushing from impact. The interior ridges are increased diameter towards the medial plane of the rim to a value greater than the specified tire bead diameter. Given this geometry, the left lateral and right lateral of each tire bead is safely constrained within the defined bead seats under a wide variety of uses.

Located between the two bead retaining seats within the central region of the rim circumference is a channel or channels having sufficient depth to allow installation of tire beads over the sidewalls with minimal manual effort.

The rim can be produced from materials providing suitable mechanical properties such as carbon fiber, aluminum alloy, metal alloy, steel, titanium, or other materials.

### BRIEF DESCRIPTION OF THE DRAWINGS

The accompanying drawings or diagrams illustrate the areas of specification and various examples of execution of the descriptions herein. The illustrated examples are merely examples and do not limit the scope of the claims.

FIG. 1 is a diagram of an illustrative bicycle wheel rim profile that includes tire bead seat retention according to principles described herein, where the dotted lines are areas not of interest for the claims herein.

FIG. 2 is a profile view of a single sidewall that includes tire bead seat retention according to principles described herein.

FIG. 3 is a profile view of a single sidewall that includes tire bead seat retention according to principles described herein.

FIG. 4 is a profile view of both sidewalls that includes tire bead seat retention according to principles described herein, and a deeper center channel between the bead seats with retention

FIG. 5 is three profile views of a single sidewall that each includes a tire bead seat retention according to principles described herein.

FIG. 6 is three profile views of a single sidewall that each includes a tire bead seat retention according to principles described herein.

FIG. 7 is three profile views of a single sidewall that each includes a tire bead seat retention according to principles described herein.

FIG. 8 is three profile views of a single sidewall that each includes a tire bead seat retention according to principles described herein.

Throughout the drawings, identical reference numbers designate similar, but not necessarily identical, elements.

### DETAILED DESCRIPTION

As noted above, bicycle wheel rims retain a bicycle tire in place, and provide attachment points for spokes form an axle hub. Rim in come cases provide braking surfaces. The wheel rims are subject to a variety of forces, including forces that are generated during acceleration, turning, braking, and impacts as the tire passes over variations in the terrain, and forces exerted on the rim by the inflated tire and other forces. For high performance applications, such as jumps, descending, climbing, sprinting or bicycle racing, the mass, and rotational inertia the bicycle rim are also significant design considerations.

Utilizing a tire bead supporting platform or bead seat with minimum bead seat diameter equal to specified diameters of standard tire bead diameters, where the tire beads are bounded by a straight sidewall and a second straight sidewall of optimized thickness wherein the sidewalls do not have tire bead hooks, and the rim's tire bead seat platforms support and center the tire to the wheel's radial center inwardly from each sidewall towards the center line of the rim, and the tire beads are retained on the rim bead seat by steps or ridges or by having bead seat platforms increasing in diameter inwardly to a greater than specified tire bead diameter, and between the bead retaining seats is a more inward section or sections having depth sufficient to install tire beads over the sidewalls requiring minimal manual effort.

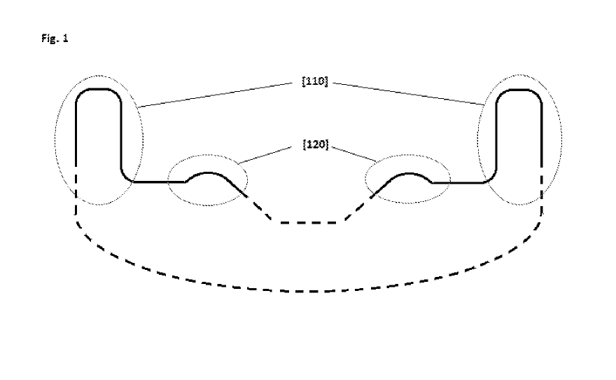

FIG. 1 shows a profile view of an illustrative bicycle rim which includes very strong thick short and thick rim walls [110] and one example of tire bead centering seats with bead retention ridges (020), according to novel principles disclosed herein.).

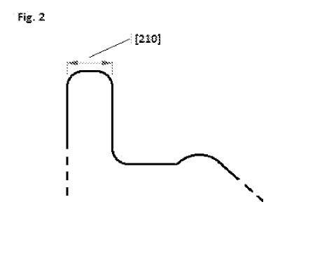

FIG. 2 is a profile view of a single sidewall that includes tire bead seat retention according to principles described herein. The sidewalls with straight bead facing walls, and the walls outward from the bead seat platform is no less than 0.10 inch to 0.30 inch in cross section thickness, excepting where there is a rounded and/or angled outermost surface to avoid sharply edged corners [210].

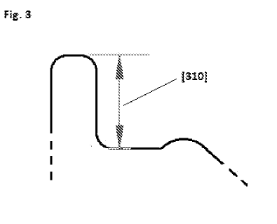

FIG. 3 is a profile view of a single sidewall that includes tire bead seat retention according to principles described herein . Having sidewall height extending outward from the tire bead seat minimum diameter, from 0.175 inches to 0.220 inches in height outward from the bead seat [310].

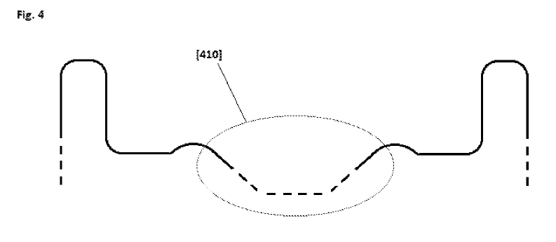

FIG. 4 is a profile view of both sidewalls that includes tire bead seat retention according to principles described herein, and a deeper center channel between the bead seats with retention. The rim having a center section or multiple centrally-located sections of deep channel(s) smaller than the minimum bead diameter sufficient to install tire beads over the sidewalls whereby the manual effort to remove or install the tire is not prohibitive. The deep channel section(s) feature sloped side angles or curved slope sides rising to the maximum height of the retention ridge features [410]. Below the sloped or curved sidewalls of the deep channel section or sections near the retaining bead seats is not a subject of the innovations described herein.

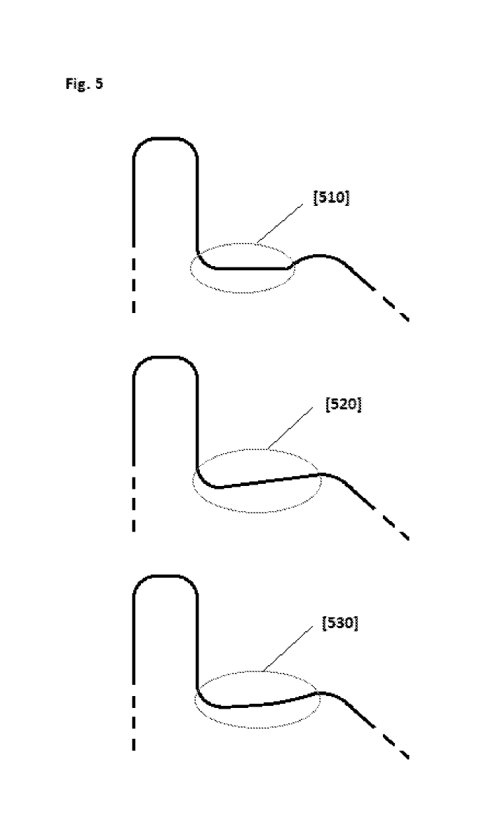

FIG. 5 is three profile views of a single sidewall that each includes a tire bead seat retention according to principles described herein. The rim has tire centering bead seats, which the tire bead centering and supporting surface comprises of a level platform [510], or inwardly slightly upward angled [520], or semi-cupping platform [530].

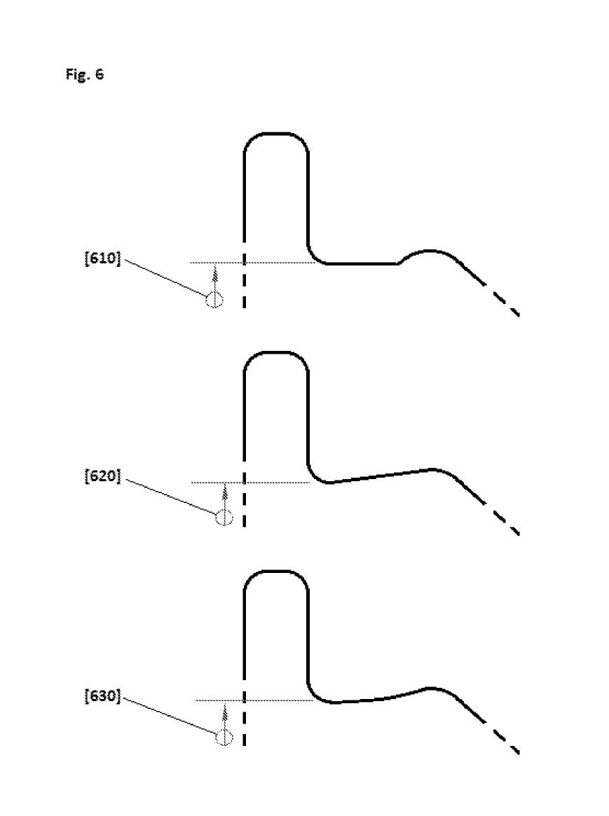

FIG. 6 is three profile views of a single sidewall that each includes a tire bead seat retention according to principles described herein. The tire supporting and centering surface nearest each sidewall features a minimum diameter centering at the wheel axial center equal to the specified tire bead inner radial diameter. For 26″ beaded tires, the standard tire bead specification is 559 mm, for 27.5″/650b tires, the specification is 584 mm, for 29″/700c tires, the standard is 622 mm [610], [620], [630].

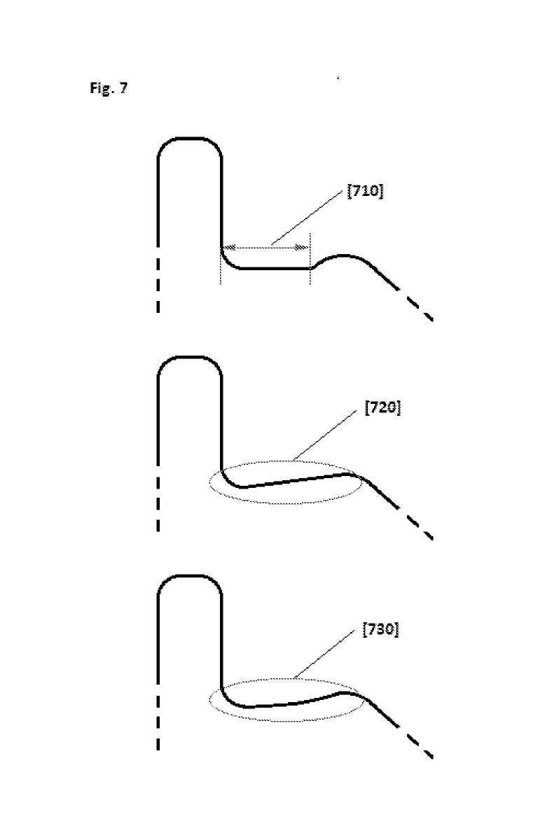

FIG. 7 is three profile views of a single sidewall that each includes a tire bead seat retention according to principles described herein. The tire supporting and centering surface comprises elevated retention features having a highest point radially outward from the wheel axial center which is greater than the bead seat diameter specification; either, a small in width ridge beginning to rise no less than 0.135 inch and no more than 0.170 inch inwardly from each sidewall's inside facing surface of a level bead seat platform [710]; or inwardly from each sidewall, a slightly upward angled bead platform [720]; or inwardly from each sidewall, a rising rate semi-cupping bead retaining surface [730]; such that a tire beads must expand during inflation or deflated removal to go over the elevated retention features.

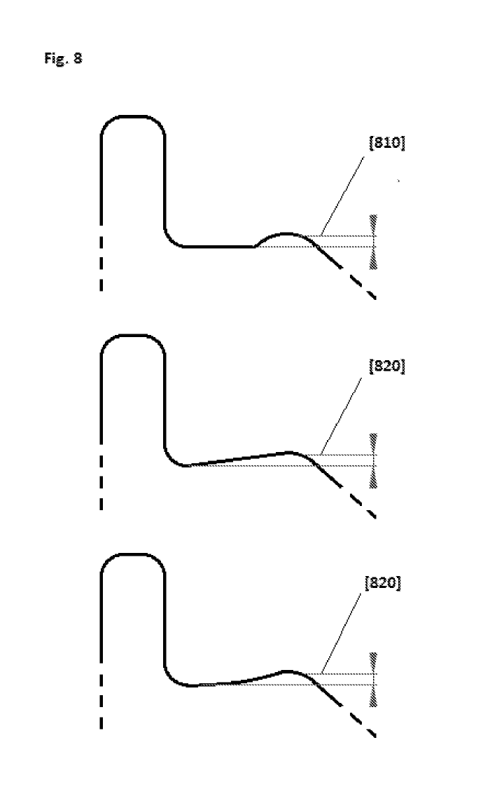

FIG. 8 is three profile views of a single sidewall that each includes a tire bead seat retention according to principles described herein. The rim of claim 8, in which the various forms of elevated retention features have a height between 0.010 inches and 0.030 inches [810], [820], [830]

### Patent Citations

| Cited Patent | Filing date | Publication date | Applicant | Title |
|---|---|---|---|---|
| U.S. Pat. No. 365,091 * | | Jun. 21, 1887 | Velocipede | |
| U.S. Pat. No. 438,383 * | Jul. 16, 1890 | Oct. 14, 1890 | Wheel | |
| U.S. Pat. No. 482,392 * | | Sep. 13, 1892 | Cushion felly and tire | |
| U.S. Pat. No. 2,198,978 * | Aug. 26, 1938 | Apr. 30, 1940 | T R Rooney | Rim construction |
| U.S. Pat. No. 2,338,066 * | Jul. 29, 1941 | Dec. 28, 1943 | Weston Alfred C | Tire and tire rim |
| U.S. Pat. No. 2,937,905 * | Nov. 23, 1956 | May 24, 1960 | Karl Altenburger | Spoke connection for tubeless tire |
| | | | | rim |
| U.S. Pat. No. 2,977,153 * | Dec. 20, 1956 | Mar. 28, 1961 | American Mach & Foundry | Tire rim |
| U.S. Pat. No. 3,008,770 * | Dec. 19, 1956 | Nov. 14, 1961 | American Mach & Foundry | Rim for tubeless bicycle tires |
| U.S. Pat. No. 3,915,215 * | Mar. 26, 1973 | Oct. 28, 1975 | Dunlop Ltd | Pneumatic tire and wheel assembly |
| U.S. Pat. No. 4,151,870 * | Mar. 8, 1977 | May 1, 1979 | The Goodyear Tire & Rubber | Wheel with |
| | | | Company | improved tire bead retainer |
| U.S. Pat. No. 4,190,092 * | Nov. 3, 1977 | Feb. 26, 1980 | Kelsey-Hayes Co. | Wheel rim |
| U.S. Pat. No. 4,351,382 * | Dec. 2, 1980 | Sep. 28, 1982 | Dunlop Limited | Tire and wheel rim assemblies |
| U.S. Pat. No. 4,487,456 * | Nov. 17, 1982 | Dec. 11, 1984 | Swiss Aluminium Ltd. | Wheel disc cast in situ with |
| | | | | interlocking rim |
| U.S. Pat. No. 4,824,177 * | Oct. 29, 1987 | Apr. 25, 1989 | Aloy Jorge N | Spoked vehicle wheel with tubeless tire |
| U.S. Pat. No. 6,155,651 * | Apr. 30, 1999 | Dec. 5, 2000 | Inoac Elastomer Co. Ltd. | Bicycle spoke rim wheel for |
| | | | | tubeless tire |
| US20060108041 * | Nov. 16, 2005 | May 25, 2006 | Ktm Sportmotorcycle Ag | Spoke wheel rim for |
| | | | | tubeless tires |
| US20090115240 * | Aug. 30, 2006 | May 7, 2009 | Mark Slate | Bicycle wheel rim |
| U.S. Pat. No. 6,257,676 * | Jul. 24, 1998 | Jul. 10, 2001 | Mavic S.A. | Bicycle rim provided for a tubeless |
| | | | | assembly and bicycle wheel |
| US20110084543 * | | Apr. 14, 2011 | Reynolds Cycling Llc | Bead Seat Clincher |

1. A bicycle rim comprising a wheel which features automatic axial centering of its associated mounted tire and bead supporting surface (bead seat) which constrains a beaded tire. Each bead seat is comprised of a first straight sidewall and a second straight sidewall wherein said bicycle rim does not implement bead hooks. The tire beads are retained and restrained next to the sidewalls adjacent to the bead seat. The tire beads allow sufficient rim sidewall clearance such that tire installation and removal over the rim sidewalls is easily achieved by the user during mounting and dismounting operations of the tire.

2. The rim of claim 1, which can be produced from any suitable material, for example metals such as aluminum alloy, steel, titanium; carbon-fiber; plastic; wood; and the like.

3. The rim of claim 1, having sidewalls with straight bead facing walls, and the walls outward from the bead seat platform is no less than 0.10 inch to 0.30 inch in cross section thickness, excepting where there is a rounded and/or angled outermost surface to avoid sharply edged corners. (FIG. 2.)

4. The rim of claim 1, having sidewall height extending outward from the tire bead seat minimum diameter, from 0.175 inches to 0.220 inches in height outward from the bead seat. (FIG. 3.)

5. The rim of claim 1, having a center section or multiple centrally-located sections of deep channel(s) smaller than the minimum bead diameter sufficient to install tire beads over the sidewalls whereby the manual effort to remove or install the tire is not prohibitive. The deep channel section(s) feature sloped side angles or curved slope sides rising to the maximum height of the retention ridge features. (FIG. 4.)

6. The rim of claim 1, in which the tire bead centering and supporting surface comprises of a level platform, or inwardly slightly upward angled, or semi-cupping platform. (FIG. 5.)

7. The rim of claim 1, in which the tire supporting and centering surface nearest each sidewall features a minimum diameter centering at the wheel axial center equal to the specified tire bead inner radial diameter. For 26″ beaded tires, the standard tire bead specification is 559 mm, for 27.5″/650b tires, the specification is 584 mm, for 29″/700c tires, the standard is 622 mm. (FIG. 6.)

8. The rim of claim 1, in which the tire supporting and centering surface comprises elevated retention features having a highest point radially outward from the wheel axial center which is greater than the bead seat diameter specification; either, a small in width ridge beginning to rise no less than 0.135 inch and no more than 0.170 inch inwardly from each sidewall's inside facing surface of a level bead seat platform; or inwardly from each sidewall, a slightly upward angled bead platform; or inwardly from each sidewall, a rising rate semi-cupping bead retaining surface; such that a tire beads must expand during inflation or deflated removal to go over the elevated retention features. (FIG. 7.)

9. The rim of claim 1, in which the various forms of elevated retention features have a height between 0.010 inches and 0.030 inches. (FIG. 8.)

10. The rim of claim 1, in which the elevated retention features are between the ascending slopes and cups such that the tire beads are expanded by air inflation pressure, so they travel up the ascending slopes and then fixate between the two constraining sidewalls and supporting surface of the bead seats.

11. The rim of claim 1, in which the tire is a tubeless tire, utilizing liquid sealant fluid to seal the tire sidewall if porous to air, and all irregularities between the tire bead and rim surface while fully inflated. Additionally the liquid sealant will seal smaller holes and punctures in the tire.

12. The rim of claim 1, also facilitates an inner tube within the tire.
